(19) United States
(12) Patent Application Publication
(10) Pub. No.: US 2007/0018926 A1
(43) Pub. Date: Jan. 25, 2007

(54) Display device and thin film transistor array panel

(75) Inventors: Yong-Hwan Shin, Yongin-si (KR); Jeong-Uk Heo, Seongnam-si (KR); Baek-Kyun Jeon, Yongin-si (KR); Yong-Kuk Yun, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/439,836

(22) Filed: May 24, 2006

(30) Foreign Application Priority Data
Jul. 19, 2005 (KR) 10-2005-0065365

(51) Int. Cl. G09G 3/36

(52) U.S. Cl. 345/92

(57) ABSTRACT

A display device is provided, which includes a first panel having a transparent electrode, and a second panel facing the first panel and having a plurality of first display signal lines, a plurality of second display signal lines intersecting the first display signal lines, a plurality of switching elements connected to one of the first display signal lines and one of the second display signal lines, a plurality of pixel electrodes connected to the switching elements, and a voltage wire being separate from the first and second display signal lines, the switching elements, and the pixel electrodes and that is supplied with a voltage from an external device; and the second panel further has a plurality of voltage input lines extending from the voltage wire and an input portion for receiving the voltage from the external device, respectively, and a plurality of shorting portions respectively electrically contacted at the voltage input lines and electrically connected to the transparent electrode of the first panel, and detection pads are formed between one of the voltage input lines and the shorting portion or between adjacent shorting portions.

### CROSS-REFERENCE TO RELATED APPLICATION

The present application claims foreign priority under 35 U.S.C. § 119 to Korean Patent Application No. 2005-0065365, filed on Jul. 19, 2005 in the Korean Intellectual Property Office, the disclosure of which is herein incorporated by reference in its entirety.

### BACKGROUND OF THE INVENTION

(a) Field of the Invention

The present invention relates to display devices, and more particularly relates to temperature sensors for thin film transistor array panels.

(b) Description of Related Art

Liquid crystal displays (LCDs) include a pair of panels provided with field generating electrodes and a liquid crystal (LC) layer having dielectric anisotropy, which is disposed between the two panels. The field generating electrodes generally include a plurality of pixel electrodes arranged in a matrix and connected to switching elements, such as thin film transistors (TFTs), to be supplied with data voltages for every row, and a common electrode covering an entire surface of a panel and supplied with a common voltage. A pair of field generating electrodes that generate the electric field in cooperation with each other and a liquid crystal disposed therebetween form a so-called liquid crystal capacitor that is a basic element of a pixel along with a switching element.

The LCD applies the voltages to the field generating electrodes to generate an electric field to the liquid crystal layer, and the strength of the electric field can be controlled by adjusting the voltage across the liquid crystal capacitor. Since the electric field determines the orientations of liquid crystal molecules and the molecular orientations determine the transmittance of light passing through the liquid crystal layer, the light transmittance is adjusted by controlling the applied voltages and thereby providing desired images. In the LCD, a plurality of signal lines are formed on the lower panel having pixel electrodes, and thereby signals and voltages such as image signals and a common voltage are applied through the signal lines.

In addition, since separate signal lines for transmitting signals or voltages are not formed on the upper panel having the common electrode, the common electrode of the upper panel receives the common voltage through the lower panel. In this case, for electrically connecting between the lower and upper panels, a plurality of shorting members are disposed at shorting points of desired positions. The shorting members may be made of conductive materials such as Ag or plastic materials containing conductive materials such as Al or Ni.

In addition, a magnitude of the common voltage transmitted through the shorting members varies in accordance with positions of the upper panel, based on a connection state of the shorting members, connection positions, or the number of shorting members, to cause image deterioration.

As resistance of a common resistor that is generated due to a difference of the common voltage between the lower panel and the upper panel becomes larger, the image deterioration increases because of the unstable common voltage. The difference of the common voltage may be generated based on the connection state of the shorting members or insufficiency of the number of shorting members, and the like.

In addition, detection pins for measuring the resistance of the common resistor are not formed. Therefore, after manufacturing the LC panel assembly by combining the upper panel and the lower panel on which the data driver for transmitting the data voltages and the gate driver for transmitting gate signals are mounted, the resistance of the common resistor is measured using a common voltage input pin formed on the data driver or the gate driver.

The resistance of the common resistor cannot be measured before the manufacturing of the LC panel assembly, and the measured resistance includes a resistance component of other resistors in addition to the common resistor such that the preciseness of the measurement decreases. When the LC panel assembly is determined to be faulty due to a high resistance value of the common resistor, the gate driver and the data driver already attached at the LC panel assembly also cannot be used.

### SUMMARY OF THE INVENTION

In an embodiment of the present invention, a display device is provided, which includes a first panel having a transparent electrode, and a second panel facing the first panel and having a plurality of first display signal lines, a plurality of second display signal lines intersecting the first display signal lines, a plurality of switching elements connected to one of the first display signal lines and one of the second display signal lines, a plurality of pixel electrodes connected to the switching elements, and a voltage wire being separate from the first and second display signal lines, the switching elements, and the pixel electrodes and that is supplied with a voltage from an external device. The second panel further includes a plurality of voltage input lines extending from the voltage wire, each having an input portion for receiving the voltage from the external device, and a plurality of shorting portions respectively electrically contacted to the voltage input lines and electrically connected to the transparent electrode of the first panel. Detection pads are formed between one of the voltage input lines and a shorting portion or between adjacent shorting portions.

The voltage wire may be supplied with a common voltage. The voltage wire or the voltage input lines may be formed at a periphery region of the second panel and may be not covered by the second panel. The shorting portions may be formed at portions at which the voltage input lines are extended, respectively. The voltage input lines may be spaced apart by 1 to 2 mm or more in a transverse direction. Each detection pad may have a size of 1 mm×1 mm. The voltage wire may be formed on the same layer as the first or second display signal lines.

In a further embodiment of the present invention, a display device is provided, which includes a first panel having a transparent electrode, and a second panel facing the first panel and having a plurality of first display signal lines, a plurality of second display signal lines intersecting the first display signal lines, a plurality of switching elements connected to one of the first display signal lines and one of the second display signal lines, a plurality of pixel electrodes connected to the switching elements, and a voltage wire being separate from the first and second display signal lines, the switching elements, and the pixel electrodes and being supplied with a voltage from an external device. The second panel further includes a plurality of voltage input lines extending from the voltage wire, and having a first input portion for receiving the voltage from the external device, a detection line extending from the voltage wire and parallel to one of the voltage input lines, and a plurality of shorting portions respectively electrically contacted to the voltage input lines and electrically connected to the transparent electrode of the first panel. Detection pads are formed between the first input portion of one of the voltage input lines and a shorting portion electrically connected to one of the voltage input lines, near the middle portion of the detection line.

The voltage wire may be supplied with a common voltage. The shorting portions may be formed at portions at which the voltage input lines are extended, respectively. The detection line may include a second input portion, and one of the detection pads is formed between the second input portion and the voltage wire. The detection line may be spaced from one of the voltage input lines by 1 to 2 mm or more in a transverse direction. Each detection pad may have a size of 1 mm×1 mm. The voltage wire may be formed on the same layer as the first or second display signal lines.

In a still further embodiment of the present invention, a thin film transistor array panel is provided, which includes a plurality of gate lines, a plurality of data lines formed on the gate lines, a passivation layer formed on the data lines, a plurality of pixel electrodes formed on the passivation layer, a common voltage line separated from the gate lines, the data lines, and the pixel electrodes and supplied with a common voltage from an external device, and a plurality of common voltage input lines extending from the common voltage line and having a input portion for receiving the common voltage. The passivation layer has a plurality of first contact holes exposing portions of the common voltage line, and the panel further includes detection pads formed between one of the input portions and one of the first contact holes corresponding to one of the input portions and between adjacent first contact holes.

The common voltage line may be formed on the same layer as the gate lines or the data lines. The passivation layer may further include a plurality of second contact holes exposing the input portions, respectively. The panel may further include first and second contact assistants connected to the common voltage lines and the input portions through the first and second contact holes, respectively.

In a still further embodiment of the present invention, a thin film transistor array panel is provided, which includes a plurality of gate lines, a plurality of data lines formed on the gate lines, a passivation layer formed on the data lines, a plurality of pixel electrodes formed on the passivation layer, a common voltage line separated from the gate lines, the data lines, and the pixel electrodes and supplied with a common voltage from an external device, a plurality of common voltage input lines extending from the common voltage line and having a input portion for receiving the common voltage, and a detection line parallel to one of the common voltage input lines. The passivation layer has a plurality of first contact holes exposing portions of the common voltage line, and the panel further includes detection pads formed between one of the input portions and one of the first contact holes corresponding to one of the input portions and near the middle of the detection line.

The common voltage line may be formed on the same layer as the gate lines or the data lines. The passivation layer may further include a plurality of second contact holes exposing the input portions, respectively. The panel may further include first and second contact assistants connected to the common voltage lines and the input portions through the first and second contact holes, respectively.

### BRIEF DESCRIPTION OF THE DRAWINGS

The present invention will become more apparent by describing preferred embodiments thereof in detail with reference to the accompanying drawings, in which:

FIG. 1 is a block diagram of an LCD according to an embodiment of the present invention;

FIG. 2 is an equivalent circuit diagram of a pixel of an LCD according to an embodiment of the present invention;

FIG. 3 is a layout view of an LCD according to an embodiment of the present invention;

FIG. 4 is a layout view of a TFT array panel for an LCD according to an embodiment of the present invention;

FIGS. 5 to 8 are sectional views of the LCD shown in FIG. 4 taken along the lines V-V, VI-VI, VII-VII, and VIII-VIII, respectively.

### DETAILED DESCRIPTION OF PREFERRED EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals may refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

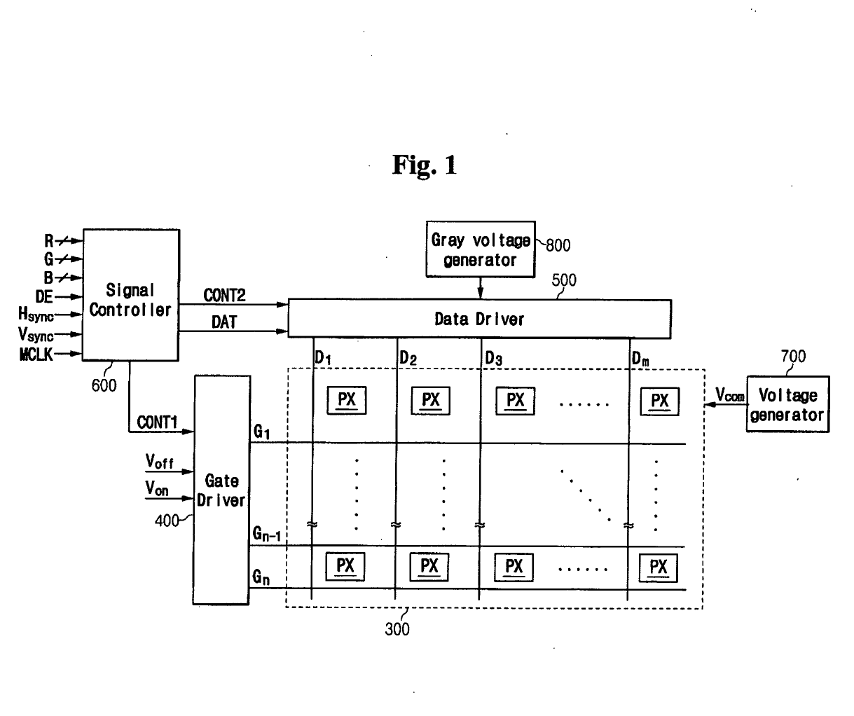

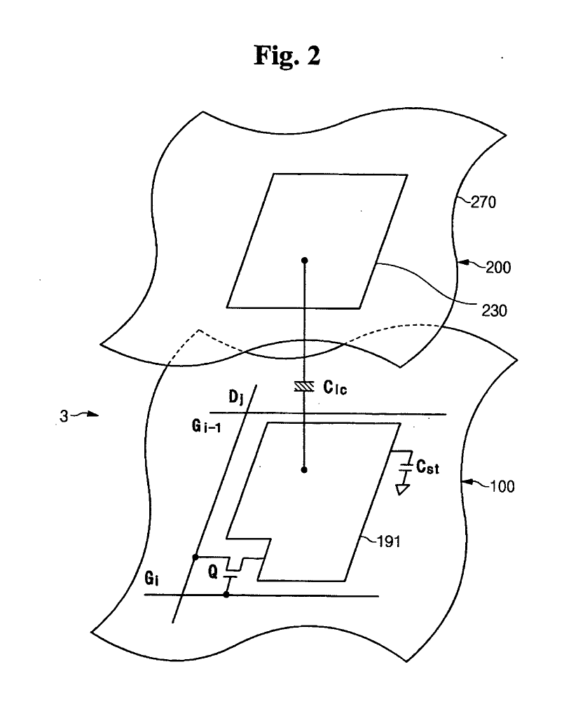

Liquid crystal displays and thin film transistor array panels according to embodiments of the present invention will be described with reference to the drawings. FIG. 1 is a block diagram of an LCD according to an embodiment of the present invention and FIG. 2 is an equivalent circuit diagram of a pixel of an LCD according to an embodiment of the present invention.

Referring to FIG. 1, an LCD according to an embodiment of the present invention includes an LC panel assembly 300, a gate driver 400 and a data driver 500 connected thereto, a gray voltage generator 800 connected to the data driver 500, a voltage generator 700, and a signal controller 600 for controlling the above-described elements.

The LC panel assembly 300, in a structural view shown in FIGS. 2, includes a lower panel 100, an upper panel 200, and an LC layer 3 interposed therebetween, and it includes a plurality of display signal lines G1-Gn and D1-Dm and a plurality of pixels PX connected thereto and arranged substantially in a matrix format in a circuital view shown in FIGS. 1 and 2.

The display signal lines G1-Gn and D1-Dm are provided on the lower panel 100, and include a plurality of gate lines G1-Gn for transmitting gate signals (called scanning signals) and a plurality of data lines D1-Dm for transmitting data signals. The gate lines G1-Gn extend substantially in a row direction and are substantially parallel to each other, while the data lines D1-Dm extend substantially in a column direction and are substantially parallel to each other.

Each pixel PX, for example a pixel PX connected to the i_th gate line Gi (i=1, 2, . . . , m) and the j_th data line Dj (j=1, 2, . . . , m), includes a switching element Q connected to the signal lines Gi and Dj, and an LC capacitor Clc and a storage capacitor Cst that are connected to the switching element Q. The storage capacitor Cst may be omitted if it is unnecessary.

The switching element Q such as a TFT is provided on the lower panel 100 and has three terminals: a control terminal connected to the gate lines Gi; an input terminal connected to the data lines Dj; and an output terminal connected to the LC capacitor Clc and the storage capacitor Cst.

The LC capacitor Clc includes a pixel electrode 191 provided on the lower panel 100 and a common electrode 270 provided on the upper panel 200, as two terminals. The LC layer 3 disposed between the two electrodes 191 and 270 functions as a dielectric of the LC capacitor Clc. The pixel electrode 191 is connected to the switching element Q, and the common electrode 270 is supplied with a common voltage Vcom and covers the entire surface of the upper panel 200. Unlike in FIG. 2, the common electrode 270 may alternately be provided on the lower panel 100, and both electrodes 191 and 270 may have shapes of bars or stripes.

The storage capacitor Cst is an auxiliary capacitor for the LC capacitor Clc. The storage capacitor Cst includes the pixel electrode 191 and a separate signal line, which is provided on the lower panel 100, it overlaps the pixel electrode 191 via an insulator, and it is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel uniquely represents one of primary colors (i.e., spatial division) or each pixel sequentially represents the primary colors in turn (i.e., temporal division), such that a spatial or temporal sum of the primary colors is recognized as a desired color. An example of a set of the primary colors includes red, green, and blue colors. FIG. 2 shows an example of the spatial division in which each pixel includes a color filter 230 representing one of the primary colors in an area of the upper panel 200 facing the pixel electrode 191. Alternatively, the color filter 230 is provided on or under the pixel electrode 191 on the lower panel 100.

A pair of polarizers for polarizing the light are attached to the outer surfaces of the panels 100 and 200 of the panel assembly 300. The gray voltage generator 800 generates two sets of a plurality of gray voltages, or two sets of a plurality of reference gray voltages, related to the transmittance of the pixels. The gray voltages in one set have a positive polarity with respect to the common voltage Vcom, while those in the other set have a negative polarity with respect to the common voltage Vcom.

The gate driver 400 is connected to the gate lines G1-Gn of the panel assembly 300, synthesizes the gate-on voltage Von and the gate off voltage Voff to generate gate signals for application to the gate lines G1-Gn, and has a plurality of integrated circuit (IC) chips.

The data driver 500 is connected to the data lines D1-Dm of the panel assembly 300 and applies data voltages selected from the gray voltages supplied from the gray voltage generator 800 to the data lines D1-Dm. In addition, when the gray voltage generator 800 does not supply the gray voltages corresponding to all grays but only supplies reference gray voltages of a predetermined number, the data driver 500 divides the reference gray voltages to generate the gray voltages corresponding to all the grays and selects data voltages from the generated gray voltages. The data driver 500 has a plurality of IC chips.

The voltage generator 700 generates a plurality of voltages, such as a common voltage Vcom, which are required for operating the LCD. The signal controller 600 controls the gate driver 400 and the data driver 500. The respective driving devices 400, 500, 600, 700, and 800 may be implemented as an IC chip mounted on the panel assembly 300, mounted on a flexible printed circuit (FPC) film as a tape carrier package (TCP) type and be attached to the LC panel assembly 300, or be mounted on a separate printed circuit board (PCB). Alternately, the driving devices 400, 500, 600, 700, and 800 may be integrated into the panel assembly 300 along with the display signal lines G1-Gn and D1-Dm and the TFT switching elements 0. In addition, the driving devices 400, 500, 600, 700, and 800 may be implemented as an IC chip, and in this time, at least one of them or at least a circuit element included in them may be implemented out of the IC chip.

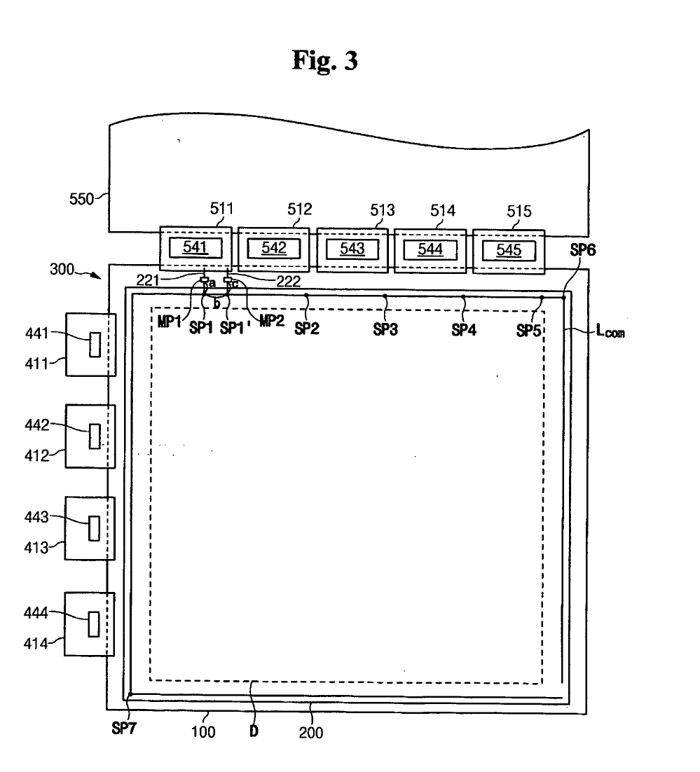

Now, a structure of the LCD according to an embodiment of the present invention will be described with reference to FIG. 3. FIG. 3 is a layout view of an LCD according to an embodiment of the present invention.

As described above, referring to FIG. 3, the LCD includes an LC panel assembly 300 having a lower panel 100 and an upper panel 200 overlapping a portion of the lower panel 100. A printed circuit board (PCB) 550 is disposed upward of the lower panel 100 on which the gate lines G1-Gn and the data lines D1-Dm are formed.

A plurality of circuit elements for driving the LCD, such as the signal controller 600, the voltage generator 700, and the gray voltage generator 800 are located on the PCB 550. A plurality of data tape carrier package (TCP) substrates 511-515 on which a plurality of data driving ICs 541-545 are mounted, respectively, are attached in a transverse direction on an upper side of the lower panel 100. The lower panel 100 and the PCB 550 are physically and electrically connected to each other through the data TCP substrates 511-515.

A plurality of gate TCP substrates 411-414 on which a plurality of gate driving ICs 441-445 are mounted, respectively, are attached in a longitudinal direction on a left side of the lower panel 100. As shown in FIG. 3, the number of gate driving ICs 441-444 is four and the number of data driving ICs 541-544 is five, but the numbers of the gate and data driving ICs may be varied based on the resolution of the LCD. A plurality of signal lines and a plurality of lead lines for transmitting signals or data are formed on the gate and data TCP substrates 411-414 and 511-515.

In FIG. 3, reference numeral “D” denotes a display region in which a plurality of pixel areas are formed to display images. In the display region D, the gate lines G1-Gn and the data lines D1-Dm intersect to each other to define the pixel areas. A periphery region outside the display region D overlaps the upper panel 200, to block light leaking out of the display region D, by using a light blocking member 220 formed on the upper panel 200 and referred to as a black matrix.

As shown in FIG. 3, a common voltage line Lcom for transmitting the common voltage Vcom is formed on the periphery region. The common voltage line Lcom substantially encloses the majority of the display region D. A plurality of shorting points SP1-SP7 are on the common voltage line Lcom, to transmit the common voltage to desired positions of the upper panel 200 via the shorting members disposed at the shorting points SP1-SP7. The upper panel 200 covers the common voltage line Lcom, and is physically and electrically connected to the lower panel 100 through the shorting members.

For applying the common voltage Vcom from the voltage generator 700 implemented on the PCB 550, a common voltage input line 221 which is connected to the shorting point SP1 is formed on the lower panel 100. In addition, a detection line 222 is formed, to be connected to a point SP1′ separated by a predetermined distance, for example, by about 1 to 2 mmor more.

The common voltage input line 221 and the detection line 222 are formed side by side in the transverse direction. Detection pads MP1 and MP2 are formed near the middle portions of the common voltage input line 221 and the detection line 222, respectively. A size of each pad MP1 and MP2 may be 1 mm □1 mm. Unlike in FIG. 3, a shorting point may be formed at the point SP1′ at which the detection line 222 is connected to the common voltage line Lcom. In addition, the detection pads MP1 and MP2 may be formed between adjacent shorting points. The detection pads MP1 and MP2 are not covered by the upper panel 200.

For being supplied with the common voltage from the voltage generator 700 mounted on the PCB 550, the common voltage input line 221 may be only connected to the data TCP substrate 511, but the detection line 222 along with the common voltage input line 221 may be connected to the data TCP substrate 511 and thereby the common voltage Vcom may be applied through both the common voltage input line 221 and the detection line 222.

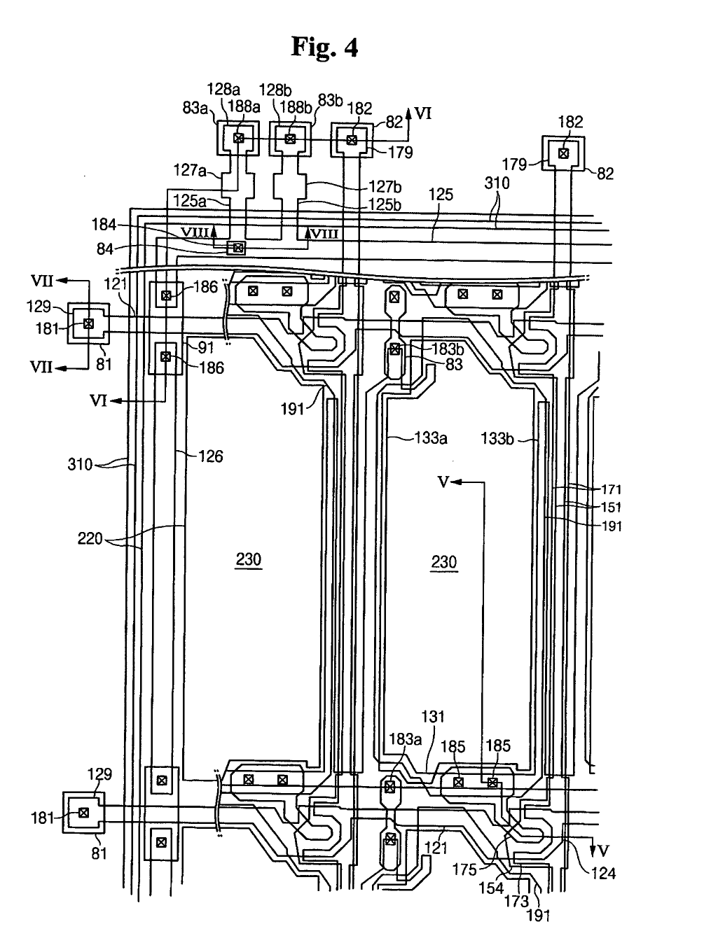

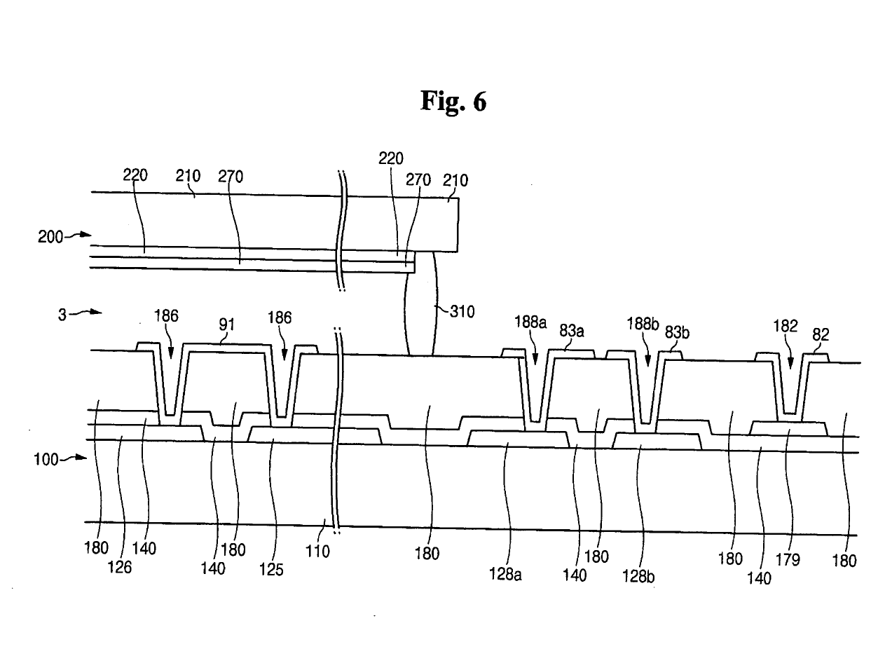

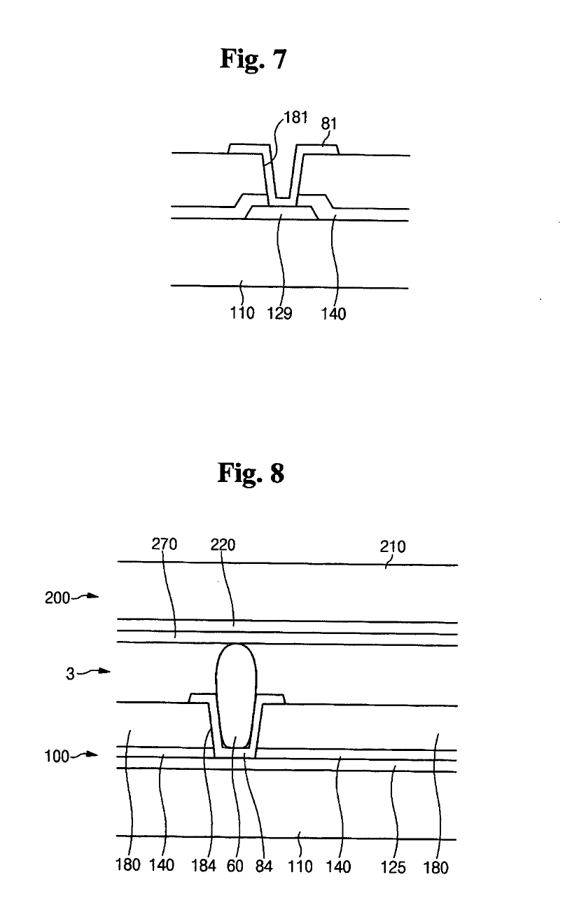

As described above, the LC panel assembly 300 includes two panels 100 and 200, and the panel 100 having thin film transistors is referred to as a TFT array panel while the panel 200 having the common electrode 270 is called a common electrode panel. Since the common voltage line Lcom, the common voltage input line 221, the detection line 222, and the detection pads MP1 and MP2 are formed on the TFT array panel 100, the TFT array panel 100 according to an embodiment of the present invention will be described in detail with reference to FIGS. 4 to 8.

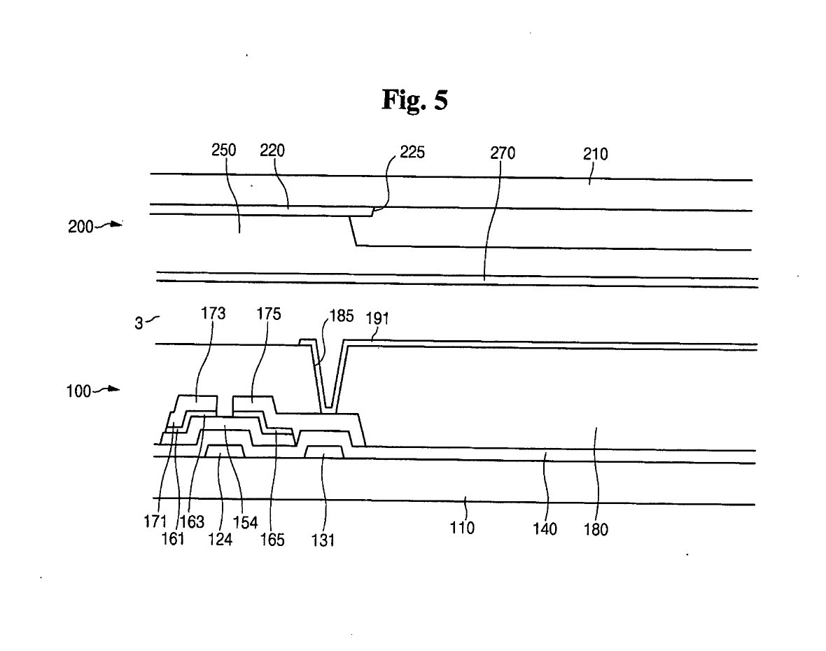

FIG. 4 is a layout view of a TFT array panel for an LCD according to an embodiment of the present invention, and FIGS. 5 to 8 are sectional views of the LCD shown in FIG. 4 taken along the lines V-V, VI-VI, VII-VII, and VIII-VIII, respectively. A plurality of gate lines 121, a plurality of storage electrode lines 131, and a plurality of common voltage lines 125 and 126 are formed on an insulating substrate 110 made of a material such as transparent glass or plastic.

The gate lines 121 transmit gate signals and extend substantially in a transverse direction. Each of the gate lines 121 includes a plurality of gate electrodes 124 projecting downward and an end portion 129 having a large area for contact with another layer or an external driving circuit. A gate driving circuit for generating the gate signals may be mounted on a flexible printed circuit (FPC) film, which may be attached to the substrate 110, directly mounted on the substrate 110, or integrated onto the substrate 110. The gate lines 121 may extend to be connected to a driving circuit that may be integrated on the substrate 110.

The storage electrode lines 131 are supplied with a predetermined voltage, and each of the storage electrode lines 131 includes a stem extending substantially parallel to the gate lines 121 and a plurality of pairs of storage electrodes 133a and 133b branched from the stems. Each of the storage electrode lines 131 is disposed between two adjacent gate lines 121, and a stem is close to one of the two adjacent gate lines 121. Each of the storage electrodes 133a and 133b has a fixed end portion connected to the stem and a free end portion disposed opposite thereto. The fixed end portion of the storage electrode 133a has a large area, and the free end portion thereof is bifurcated into a linear branch and a curved branch. In addition, the storage electrode lines 131 may have various shapes and arrangements.

The common voltage lines 125 and 126 transmit the common voltage Vcom. The common voltage lines 125 and 126 include a plurality of common voltage lines 125 extending in the transverse direction near the upper and lower portions of the TFT array panel 100 and extending in a longitudinal direction near the right portion of the TFT array panel 100, and a plurality of island common voltage lines 126 extending in the longitudinal direction between adjacent gate lines 121 near the left portion of the TFT array panel 100 at which the end portions 129 of the gate lines 121 are formed.

The storage electrode lines 131 may be connected to the common voltage lines 125 and 126, to be supplied with the common voltage Vcom applied to the common voltage lines 125 and 126. Alternatively, the storage electrode lines 131 may be connected to common voltage lines 125 and 126 through resistors, to be supplied with a voltage having a magnitude different from that of the common voltage Vcom applied to the common voltage lines 125 and 126.

The common voltage line 125 formed near the upper portion of the TFT array panel 100 includes a common voltage input line 125a and a detection line 125b that is parallel to the common voltage input line 125a. The common voltage input line 125a and the detection line 125b include detection pads 127a and 127b formed at about the middle portions thereof and having a large area, and end portions 128a and 128b having a large area for contact with another layer or an external driving circuit, respectively. Alternatively, the detection line 125b may not have the end portion 128b.

The detection pads 127a and 127b are not covered by the upper panel 200, and are thereby exposed to the outside when the lower panel 100 is assembled with the upper panel 200 to manufacture the LC panel assembly 300. As described above, preferably, a size of each detection pad 127a and 127b is about 1 mm□1 mm.

The gate lines 121, the storage electrode lines 131, and the common voltage lines 125 and 126 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ta, or Ti. In addition, they may have a multi-layered structure including two conductive films having different physical characteristics. One of the two films is preferably made of a low resistivity metal such as an Al-containing metal, a Ag-containing metal, and a Cu-containing metal for reducing signal delay or voltage drop. The other film is preferably made of a material such as a Mo-containing metal, Cr, Ta, or Ti, which have good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. In addition, the gate lines 121, the storage electrode lines 131, and the common voltage lines 125 and 126 may be made of various metals or conductors. The lateral sides of the gate lines 121, the storage electrode lines 131, and the common voltage lines 125 and 126 are inclined relative to a surface of the substrate 110, and the inclination angle thereof ranges about 30-80 degrees. A gate insulating layer 140 preferably made of silicon nitride (SiNx) or silicon oxide (SiOx) is formed on the gate lines 121, the storage electrode lines 131, and the common voltage lines 125 and 126.

A plurality of semiconductor stripes 151 preferably made of hydrogenated amorphous silicon (abbreviated to “a-Si”) or polysilicon are formed on the gate insulating layer 140. The semiconductor stripes 151 extend substantially in the longitudinal direction and become wide near the gate lines 121 and the storage electrode lines 131 such that the semiconductor stripes 151 cover large areas of the gate lines 121 and the storage electrode lines 131. Each of the semiconductor stripes 151 includes a plurality of projections 154 branched out toward the gate electrodes 124.

A plurality of ohmic contact stripes and islands 161 and 165 are formed on the semiconductor stripes 151. The ohmic contact stripes and islands 161 and 165 are preferably made of n+hydrogenated a-Si heavily doped with an N-type impurity such as phosphorous, or they may be made of silicide. Each ohmic contact stripe 161 includes a plurality of projections 163, and the projections 163 and the ohmic contact islands 165 are located in pairs on the projections 154 of the semiconductor stripes 151. The lateral sides of the semiconductor stripes 151 and the ohmic contacts 161 and 165 are inclined relative to the surface of the substrate 110, and the inclination angles thereof are preferably in a range of about 30-80 degrees.

A plurality of data lines 171 and a plurality of drain electrodes 175 are formed on the ohmic contacts 161 and 165 and the gate insulating layer 140. The data lines 171 transmit data signals and extend substantially in the longitudinal direction to intersect the gate lines 121. Each data line 171 also intersects the storage electrode lines 131 and runs between adjacent pairs of storage electrodes 133a and 133b. Each data line 171 includes a plurality of source electrodes 173 projecting toward the gate electrodes 124 and being curved like a crescent, and an end portion 179 having a large area for contact with another layer or an external driving circuit.

The end portions 179 of the data lines 171 are formed on the same line as the end portions 128a and 128b of the common voltage input line 125a and the detection line 125b in the transverse direction. A data driving circuit for generating the data signals may be mounted on an FPC film, which may be attached to the substrate 110, directly mounted on the substrate 110, or integrated onto the substrate 110. The data lines 171 may extend to be connected to a driving circuit that may be integrated on the substrate 110.

The drain electrodes 175 are separated from the data lines 171 and disposed opposite the source electrodes 173 with respect to the gate electrodes 124. Each of the drain electrodes 175 includes a wide end portion and a narrow 20 end portion. The wide end portion overlaps a storage electrode line 131 and the narrow end portion is partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175. The data lines 171 and the drain electrodes 175 are preferably made of a refractory metal such as Cr, Mo, Ta, Ti, or alloys thereof. In addition, they may have a multilayered structure including a refractory metal film and a low resistivity film. Good examples of the multi-layered structure are a double-layered structure including a lower Cr/Mo (alloy) film and an upper Al (alloy) film, and a triple-layered structure of a lower Mo (alloy) film, an intermediate Al (alloy) film, and an upper Mo (alloy) film. In addition, the data lines 171 and the drain electrodes 175 may be made of various metals or conductors. The data lines 171 and the drain electrodes 175 have inclined edge profiles, and the inclination angles thereof range about 30-80 degrees. The data lines 171 and the drain electrodes 175 may be formed by sputtering.

The ohmic contacts 161 and 165 are interposed only between the underlying semiconductor stripes 151 and the overlying conductors 171 and 175 thereon, and reduce the contact resistance therebetween. Although the semiconductor stripes 151 are narrower than the data lines 171 at most places, the width of the semiconductor stripes 151 becomes large near the gate lines 121 and the storage electrode lines 131 as described above, to smooth the profile of the surface, thereby preventing disconnection of the data lines 171. The semiconductor stripes 151 have almost the same planar shapes as the data lines 171 and the drain electrodes 175 as well as the underlying ohmic contacts 161 and 165. In addition, the semiconductor stripes 151 include some exposed portions, which are not covered with the data lines 171 and the drain electrodes 175, such as portions located between the source electrodes 173 and the drain electrodes 175.

The common voltage lines 125 and 126 or the common voltage input line 125a and the detection line 125b may be formed on the same layer as the data lines 171 and the drain electrodes 175. A passivation layer 180 is formed on the data lines 171, the drain electrodes 175, and the exposed portions of the semiconductor stripes 151. The passivation layer 180 is preferably made of an inorganic or organic insulator and it may have a flat top surface. Examples of the inorganic insulator include silicon nitride and silicon oxide. The organic insulator may have photosensitivity and a dielectric constant of less than about 4.0. The passivation layer 180 may include a lower film of an inorganic insulator and an upper film of an organic insulator such that it takes the excellent insulating characteristics of the organic insulator while preventing the exposed portions of the semiconductor stripes 151 from being damaged with the organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133a, a plurality of contact holes 183b exposing the linear branches of the free end portions of the storage electrodes 133a, a plurality of contact holes 186 exposing end portions of the common voltage lines 125 and/or 126, contact holes 188a and 188b exposing the end portions 128a and 128b of the common voltage input line 125a and the detection line 125b, respectively, and a plurality of contact holes 184 exposing portions of the common voltage line 125.

A plurality of pixel electrodes 191, a plurality of overpasses 83, a plurality of contact assistants 81, 82, 83a, 83b, and 84, and a plurality of connecting members 91 are formed on the passivation layer 180. They are preferably made of a transparent conductor such as ITO or IZO, or a reflective conductor such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of the opposing color filter panel 200 supplied with a common voltage, which determine the orientations of liquid crystal molecules of a liquid crystal layer 3 disposed between the two panels 100 and 200. A pixel electrode 191 and the common electrode 270 form a capacitor referred to as a “liquid crystal capacitor,” which stores applied voltages after the TFT turns off.

A pixel electrode 191 overlaps a storage electrode line 131 including storage electrodes 133a and 133b. The pixel electrode 191 and a drain electrode 175 connected thereto and the storage electrode line 131 form an additional capacitor referred to as a “storage capacitor,” which enhances the voltage storing capacity of the liquid crystal capacitor.

The contact assistants 81, 82, 83a, 83b, and 84 are connected to the end portions 129 of the gate lines 121, the end portions 179 of the data lines 171, the end portions 128a and 128b of the common voltage input line 125a and the detection line 125b, and portions of the common voltage line 125 through the contact holes 181, 182, 188a, 188b, and 184, respectively. The contact assistants 81, 82, 83a, 83b, and 84 protect the portions 129, 179, 125a, 125b, and 125, and enhance the adhesion between the portions 129, 179, 125a, 125b, and 125 and external devices.

The overpasses 83 cross over the gate lines 121 and they are connected to the exposed portions of the storage electrode lines 131 and the exposed linear branches of the free end portions of the storage electrodes 133a through the contact holes 183a and 183b, respectively, which are disposed opposite each other with respect to the gate lines 121. The storage electrode lines 131 including the storage electrodes 133a and 133b along with the overpasses 83 can be used for repairing defects in the gate lines 121, the data lines 171, or the TFTs.

The connecting members 91 are connected to the common voltage lines 125 (or 126) and 126 facing each other with respect to the gate lines 121 through the contact holes 186, to electrically and physically connect the common voltage lines 125 and 126 that are electrically and physically disconnected by the gate lines 121.

The description of the common electrode panel 200 follows with reference to FIGS. 4-8. A light blocking member 220 referred to as a black matrix for preventing light leakage is formed on an insulating substrate 210 made of a material such as transparent glass or plastic.

The light blocking member 220 has a plurality of openings 225 that face the pixel electrodes 191, and it may have substantially the same planer shape as the pixel electrodes 191 and it prevents light leakage between the pixel electrodes 191. Otherwise, the light blocking member 220 may include a plurality of rectilinear portions facing the gate lines 121 and the data lines 171 on the TFT array panel 100 and a plurality of widened portions facing the TFTs on the TFT array panel 100.

A plurality of color filters 230 are also formed on the substrate 210, and they are disposed substantially in the areas enclosed by the light blocking member 220. The color filters 230 may extend substantially in the longitudinal direction along the pixel electrodes 191. The color filters 230 may represent one of the primary colors such as red, green, and blue colors.

An overcoat 250 is formed on the color filters 230 and the light blocking member 220. The overcoat 250 is preferably made of an (organic) insulator, and it prevents the color filters 230 from being exposed and provides a flat surface. The overcoat 250 may be omitted.

A common electrode 270 is formed on the overcoat 250. The common electrode 270 is preferably made of a transparent conductive material such as ITO and IZO.

Alignment layers that may be homeotropic are coated on inner surfaces of the panels 100 and 200, and polarizers are provided on outer surfaces of the panels 100 and 200 so that their polarization axes may be crossed and one of the polarization axes may be parallel to the gate lines 121. One of the polarizers 12 and 22 may be omitted when the LCD is a reflective LCD.

The LCD may further include at least one retardation film for compensating the retardation of the LC layer 3. The LCD may further include a backlight unit for supplying light to the LC layer 3 through the polarizers, the retardation film, and the panels 100 and 200.

As shown in FIG. 8, a plurality of conductive shorting members 60 are formed between the TFT array panel 100 and the common electrode panel 200. The shorting members 60 may be formed to dot conductive materials such as Ag, or they may be conductive spacers made of insulated materials such as plastic and coated with conductive materials such as Au and Ni. The shorting members 60 are disposed at the shorting points SP1-SP7 shown in FIG. 3.

The common electrode 270 of the common electrode panel 200 is electrically and physically connected to the contact assistants 84 of the TFT array panel 100 connected to the common voltage line 125 through the shorting members 60 disposed at the contact holes 184, to be supplied with the common voltage Vcom.

A sealant 310 is formed on the border of the common electrode panel 200. The sealant 310 may be made of materials hardened by UV (ultraviolet) rays. The liquid crystal is injected into the inter part enclosed by the sealant 310 to form the LC layer 3.

Now, the operation of the LCD will be described in detail. The common voltage Vcom from the voltage generator 700 mounted on the PCB 550 is transmitted to the common voltage input line 221 through a signal line formed on the data TCP substrate 511. Thereby, the common voltage Vcom is applied to the common voltage line Lcom. At this time, since the common electrode 270 of the common electrode panel 200 has already been connected to the common voltage line Lcom formed on the TFT array panel 100 via the shorting members 60 at the shorting points SP1-SP7, the common electrode 270 is supplied with the common voltage Vcom as the common voltage Vcom is applied to the common voltage line Lcom.

In addition, instead of the common voltage Vcom being applied to the common voltage line Lcom using the one common voltage input line 221, the common voltage Vcom may be applied to the common voltage line Lcom using a plurality of common voltage input lines connected to the shorting points SP1-SP6 adjacent to the data TCP substrates 511-515, respectively, which are formed on the TFT array panel 100. That is, the common voltage Vcom may be separately applied to each shorting point SP1-SP6.

The signal controller 600 is supplied with RGB image signals R, G, and B and input control signals for controlling the display of the RGB image signals R, G, and B from an external graphic controller. Examples of the input control signals are a vertical synchronization signal Vsync, a horizontal synchronization signal Hsync, a main clock signal MCLK, and a data enable signal DE.

After generating gate control signals CONT1 and data control signals CONT2 and processing the image signals R, G, and B to be suitable for the operation of the panel assembly 300 on the basis of the input control signals, the signal controller 600 provides the gate control signals CONT1 for the gate driver 400, and the processed image signals DAT and the data control signals CONT2 for the data driver 500.

The gate control signals CONT1 include a scanning start signal STV for instructing to start scanning, and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing to apply the data voltages to the data lines D1-Dm, and a data clock signal HCLK. The data control signal CONT2 may further include an inversion signal RVS for reversing the polarity of the data voltages (with respect to the common voltage Vcom).

In response to the data control signals CONT2 from the signal controller 600, the data driver 500 receives a packet of the image data DAT for the group of pixels from the signal controller 600, converts the image data DAT into analog data voltages selected from the gray voltages supplied from the gray voltage generator 800, and applies the data voltages to the data lines D1-Dm.

The gate driver 400 applies the gate-on voltage Von to the gate line G1-Gn in response to the gate control signals CONT1 from the signal controller 600, thereby turning on the switching elements Q connected thereto. The data voltages applied to the data lines D1-Dm are supplied to the pixels through the activated switching elements Q.

The difference between the data voltage and the common voltage Vcom is represented as a voltage across the LC capacitor Clc, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance.

By repeating this procedure by a unit of the horizontal period, which is denoted by “1H” and is equal to one period of the horizontal synchronization signal Hsync and the data enable signal DE, all gate lines G1-Gn are sequentially supplied with the gate-on voltage Von during a frame, thereby applying the data voltages to all pixels.

The procedure will be described in further detail below. The uppermost gate driving IC 441 that firstly receives the vertical synchronization start signal STV selects the gate-on voltage Von from the two voltages Von and Voff from an external device, and successively outputs the selected gate-on voltage Von from the first gate line G1. At this time, all the other gate lines which are not supplied with the gate-on voltage Von receive the gate-off voltage Voff.

Meanwhile, the leftmost data driving IC 541, having all its image signals stored, receives image data for a subsequent data driving IC 542 and transmits them to the adjacent data driving IC 542 via signal lines. In this way, each data driving IC 541-545, having its image data stored, receives image data for subsequent data driving ICs 542-545 and transmits them to an adjacent data driving IC 542-545 via signal lines.

Switching elements Q connected to the first gate line G1 are turned on by the gate-on voltage Von, and data signals for the first row are applied to the LC capacitors Clc and the storage capacitors Cst of all pixels in the first row through the turned-on switching elements Q.

When the charging of the capacitors Clc and Cst in the first row is finished in a predetermined period, the uppermost (i.e., first) gate driving IC 441 applies the gate-off voltage Voff to the first gate line G1 such that the switching elements Q connected thereto are turned off, and applies the gate-on voltage Von to the second gate line G2.

When all the gate lines connected to the first gate driving IC 441 have been applied with the gate-on voltage Von, the first gate driving IC 441 supplies a carry signal, i.e., a signal for notifying of the finish of scanning, to the second gate driving IC 442.

Upon receipt of the carry signal, the second gate driving IC 442 executes scanning, in the same way as described above, for all gate lines connected thereto. When the scanning for all its gate lines is finished, the second gate driving IC 442 supplies the carry signal to a subsequent gate driving IC 443. When the final gate driving IC 444 finishes its scanning operation in this way, a frame is fully processed.

When the next frame starts after finishing one frame, the inversion control signal RVS applied to the data driver 500 is controlled such that the polarity of the data voltages is reversed, which is referred to as “frame inversion”. The inversion control signal RVS may also be controlled such that the polarity of the data voltages flowing in a data line in one frame is reversed, such as, for example, line inversion and dot inversion, or the polarity of the data voltages in one packet is reversed, such as, for example, column inversion and dot inversion.

A method for detecting resistance of a common resistor Rcom in the LCD will be described with reference to FIG. 3. After the manufacturing of the TFT array panel 100, the common electrode panel 200 is assembled to the TFT array panel 100, to manufacture the LC panel assembly 300. At this time, liquid crystal may not be injected between the panels 100 and 200.

A user contacts probes of a resistance tester to the detection pads MP1 and MP2 to measure resistance. At this time, the measured resistance may be measured using a current flowing after application of a predetermined voltage to the detection pads MP1 and MP2 through the probes. When disregarding a resistance generated by the probes, the measured resistance is the sum of resistance of a common resistor at the detection pad MP1, resistance of a wire resistor between the lines 221 and 222, and resistance of a common resistor at the detection pad MP2. The wire resistance is the total sum of a wire resistance generated at a line “a” between the detection pad MP1 and the shorting point SP1, a wire resistance generated at a line “b” between the shorting point SP1 and the point SP1′, and a wire resistance generated at a line “c” between the detection pad MP2 and the point SP1′, as shown in FIG. 3. Since the total length a+b+c of the lines is short, half of the measured resistance is resistance of the common resistor Rcom, upon disregarding the wire resistance. The measured resistance of the common resistor Rcom may be used to determine defects of the LC panel assembly 300.

As described above, since resistance of the common resistor is measured using the detection pads formed at the common voltage input line and the detection line separate therefrom, it is possible to measure resistance of a common resistor in a state such that the data driving ICs and the gate driving ICs are not attached on the LC panel assembly. Thereby, unnecessary waste of data and gate driving ICs decreases when the manufactured LC panel assembly is determined to be faulty due to high measured resistance of the common resistor.

Moreover, since the measured resistance does not include resistance components of separate resistors except the common resistor, an exact measurement is possible. Further, when defects such as disconnections occur at the common voltage input line, the common voltage may be applied through the detection line.

While the present invention has been described in detail with reference to preferred embodiments, it is to be understood that the invention is not limited to the disclosed embodiments, but, on the contrary, is intended to cover various modifications and equivalent arrangements realizable by those of ordinary skill in the pertinent art and included within the spirit and scope of the appended claims.

What is claimed is:

1. A display device comprising:
a first panel having a transparent electrode;
a second panel facing the first panel and having a plurality of first display signal lines, a plurality of second display signal lines intersecting the first display signal lines, a plurality of switching elements connected to one of the first display signal lines and one of the second display signal lines, a plurality of pixel electrodes connected to the switching elements, and a voltage wire being separate from the first and second display signal lines, the switching elements, and the pixel electrodes and that is supplied with a voltage from an external device,
wherein the second panel further has a plurality of voltage input lines extending from the voltage wire and having an input portion for receiving the voltage from the external device, and a plurality of shorting portions electrically contacted at the voltage input lines and electrically connected to the transparent electrode of the first panel, and detection pads are formed between one of the voltage input lines and the shorting portion or between adjacent shorting portions.

2. The device of claim 1, wherein the voltage wire is supplied with a common voltage.

3. The device of claim 1, wherein the voltage wire or the voltage input lines are formed at a periphery region of the second panel.

4. The device of claim 3, wherein the voltage wire or the voltage input lines are not covered with the second panel.

5. The device of claim 1, wherein the shorting portions are formed at portions at which the voltage input lines are extended, respectively.

6. The device of claim 1, wherein the voltage input lines are spaced by 1 to 2 mm or more in a transverse direction.

7. The device of claim 1, wherein each detection pad has a size of 1 mm×1 mm.

8. The device of claim 1, wherein the voltage wire is formed on the same layer as the first or second display signal lines.

9. A display device comprising:
a first panel having a transparent electrode;
a second panel facing the first panel and having a plurality of first display signal lines, a plurality of second display signal lines intersecting the first display signal lines, a plurality of switching elements connected to one of the first display signal lines and one of the second display signal lines, a plurality of pixel electrodes connected to the switching elements, and a voltage wire being separate from the first and second display signal lines, the switching elements, and the pixel electrodes and that is supplied with a voltage from an external device,
wherein the second panel further has a plurality of voltage input lines extending from the voltage wire and having a first input portion for receiving the voltage from the external device, respectively, a detection line extending from the voltage wire and parallel to one of the voltage input lines, and a plurality of shorting portions respectively electrically contacted at the voltage input lines and electrically connected to the transparent electrode of the first panel, and detection pads are formed between the first input portion of one of the voltage input lines and a shorting portion electrically connected to one of the voltage input lines and near the middle portion of the detection line.

10. The device of claim 9, wherein the voltage wire is supplied with a common voltage.

11. The device of claim 9, wherein the shorting portions are formed at portions at which the voltage input lines are extended, respectively.

12. The device of claim 9, wherein the detection line comprises a second input portion, and one of the detection pads is formed between the second input portion and the voltage wire.

13. The device of claim 9, wherein the detection line is spaced from one of the voltage input lines by 1 to 2 mm or more in a transverse direction.

14. The device of claim 9, wherein each detection pad has a size of 1 mm×1 mm.

15. The device of claim 9, wherein the voltage wire is formed on the same layer as the first or second display signal lines.

16. A thin film transistor array panel comprising:
a plurality of gate lines;
a plurality of data lines formed on the gate lines;
a passivation layer formed on the data lines;
a plurality of pixel electrodes formed on the passivation layer;
a common voltage line separated from the gate lines, the data lines, and the pixel electrodes and be supplied with a common voltage from an external device; and
a plurality of common voltage input lines extending from the common voltage line and having an input portion receiving the common voltage,
wherein the passivation layer has a plurality of first contact holes exposing portions of the common voltage line, and wherein the panel further comprises detection pads formed between one of the input portions and one of the first contact holes corresponding to one of the input portions and between adjacent first contact holes.

17. The panel of claim 16, wherein the common voltage line is formed on the same layer as the gate lines or the data lines.

18. The panel of claim 16, wherein the passivation layer further comprises a plurality of second contact holes exposing the input portions, respectively.

19. The panel of claim 16, further comprising first and second contact assistants connected to the common voltage lines and the input portions through the first and second contact holes, respectively.

20. A thin film transistor array panel comprising:
a plurality of gate lines;
a plurality of data lines formed on the gate lines;
a passivation layer formed on the data lines;
a plurality of pixel electrodes formed on the passivation layer;
a common voltage line separated from the gate lines, the data lines, and the pixel electrodes and be supplied with a common voltage from an external device;
a plurality of common voltage input lines extending from the common voltage line and having a input portion for receiving the common voltage; and
a detection line parallel to one of the common voltage input lines,
wherein the passivation layer has a plurality of first contact holes exposing portions of the common voltage line, and wherein the panel further comprises detection pads formed between one of the input portions and one of the first contact holes corresponding to one of the input portions and near the middle of the detection line.

21. The panel of claim 20, wherein the common voltage line is formed on the same layer as the gate lines or the data lines.

22. The panel of claim 20, wherein the passivation layer further comprises a plurality of second contact holes exposing the input portions, respectively.

23. The panel of claim 22, further comprising first and second contact assistants connected to the common voltage lines and the input portions through the first and second contact holes, respectively.
